(19) United States
(12) Patent Application Publication
(10) Pub. No.: US 2026/0045278 A1
(43) Pub. Date: Feb. 12, 2026

(54) METHOD AND SYSTEM FOR INSTANT ON-DEMAND VOICE RECORDING

(71) Applicant: Greg Park, Wayzata, MN (US)

(72) Inventor: Greg Park, Wayzata, MN (US)

(21) Appl. No.: 18/799,798

(22) Filed: Aug. 9, 2024

(51) Int. Cl. G11B 20/10; G06F 9/451; G10L 15/18; G10L 15/22; G10L 15/26

(52) U.S. Cl. CPC G11B 20/10527; G06F 9/451; G10L 15/1822; G10L 15/22; G10L 15/26; G10L 2015/223; G11B 2020/10546

(57) ABSTRACT

Systems, methods, and other embodiments associated with a voice recording application for obtaining and processing audible content with minimal to zero user interaction that may be stored on a server and accessible by multiple client computing devices are described. In one embodiment, a method includes detecting, by a mobile computing device, a first activity and in response to the detecting the first activity, performing a first action. The example method may also include displaying, on a graphical user interface (GUI) of the mobile computing device, a voice memo recording application, and recording audio from a microphone of the mobile computing device prior to the displaying of the voice memo recording application.

### TECHNICAL FIELD

The embodiments generally relate to voice recording software, and more particularly, relates to methods, systems and computer readable media for instant on-demand voice recording, automatic recording start/stop, and file transfer.

### BACKGROUND

The sheer volume of applications and software for user consumption on mobile and computing device makes possible convenient storage of data from one device and access of the stored data from multiple devices around the world at any time. App developers may focus on providing robust customizable mobile apps that grab a user's attention and persuade them to purchase a mobile app. These mobile apps provide users with fancy interactions, vibrant colors, themes, features, settings, and customizations to incentivize users to purchase the mobile app. In doing so, however, mobile applications can often demand a user's attention for proper navigation and item selection within the user interface of the mobile app. Even simple recording or notetaking mobile apps can have significantly different interfaces, behaviors, and actions requiring users to focus intently on navigating through the app to select a desired function. Several problems exist in present notetaking/recording mobile apps for active users such as vehicle operators, drivers, and busy or working persons wanting to take notes of ideas or thoughts.

One problem in existing notetaking/recording mobile apps is that upon each execution of the mobile app, users may need to pause an activity to visually engage and inspect the location of selection items/objects (e.g., stop or record button) or navigational objects (e.g., presets, user settings) within the mobile app user interface to correctly make a desired selection. Moreover, to make room for textual listings, tables, features, or other objects within the user interface of the notetaking/recording app, selectable items/objects and navigational objects are made small and distally located on the user interface making them difficult to reach, see, or press for active users. Users may often find themselves away from their desk, mobile device, or writing instrument, or in the middle of a task or activity making it difficult to repeatedly take notes of ideas or thoughts using existing notetaking and recording mobile apps.

Another problem in existing notetaking/recording mobile apps is the mobile app user interface may require users to navigate through multiple screens and menus such as the user dashboard, app screen, or settings to configure the mobile app behavior or access recorded files and app settings.

Another problem in existing notetaking/recording mobile apps is the need for multiple steps and interactions to start and stop a note/recording to record one note, for example, the user may need to open the app, reach to and press the play/record button, and then unlock the device, return to the app, and reach to and press the stop button to complete recording of one note. To record and save sequences of thoughts or multiple notes, users can often find themselves performing numerous and repeated steps that cause them to be distracted from performing a task or activity such as driving or working in order to open the notetaking/recording app to take notes of ideas or thoughts.

Further, when users are busy with a task or activity, the needed attention and multiple steps required to record one note or thought can often lead to inaccurate recordings as the user might think they opened an app and pressed the record button but their finger may have missed the button and would have failed to record a note or thought. Similarly, if the user missed the stop button, they could end up with a longer recording than intended. While, voice assistants and voice activation settings of the mobile device can open a native recording app, they are very prone to misinterpret the user request or command and open another program or cancel the request. Further, user can often be preoccupied and lose track of the state of the recording leading to inaccurate recordings. Moreover, many voice assistants and voice activation algorithms can often be ineffective when used in loud or noisy environments or environments where internet or network connectivity is poor. Further, voice assistants and voice activation settings may often lack a stop recording command or setting requiring users to physically navigate to the app and stop a recording.

The above examples illustrate the multi-step process and inconvenience experienced by users which can be a hassle and discourages users from repeated note taking and can lead to inaccurate recordings or missed opportunities to take notes of ideas or thoughts.

### SUMMARY

Embodiments of a computer-implemented method, computing system, and computer-readable medium having instructions for an automated voice recording system are described that includes detecting, by a mobile computing device, a first activity and responsive to the detecting of the first activity, performing a first action, displaying, on a graphical user interface (GUI) of the mobile computing device, a voice memo recording application, and recording audio from a microphone of the mobile computing device after detecting the first activity. The method may further include recording audio from a microphone of the mobile computing device after detecting the first activity and prior to the displaying of the voice memo recording application. Further, the method may be configured such that the first activity includes one or more of: a voice command that triggers the mobile computing device to perform voice recognition and pressing on an object associated with execution of the voice memo recording application to launch the voice memo recording application. In one embodiment, the first action comprises displaying the voice memo recording application on a top level of the GUI overlaying the contents of the GUI display and recording audio from the microphone. The method may further detect, by a mobile computing device, a second activity and responsive to the detection of the second activity, performing a second action, the second action comprising of stopping the recording of audio.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale. A complete understanding of the present embodiments and the advantages and features thereof will be more readily understood by reference to the following detailed description when considered in conjunction with the accompanying drawings wherein:

FIG. 1 illustrates one embodiment of a computing system configured to provide a voice recording application for obtaining and processing audible content that may be stored on a server and accessible by multiple client computing devices through one or more network communication channels;

FIG. 2A illustrates one embodiment of a driver assist mode user environment for implementing the voice recording application for recording and processing audible content of FIG. 1;

FIG. 2B illustrates one embodiment of a user environment for implementing the voice recording application for recording and processing audible content of FIG. 1;

FIG. 2C illustrates one embodiment of a mobile user interface displaying the voice recording application for recording and processing audible content of FIG. 1;

FIG. 2D illustrates one embodiment of a web user interface displaying the voice recording application for recording and processing audible content of FIG. 1;

FIG. 3 illustrates one embodiment of a method performed by the system of FIG. 1 for obtaining and processing audible content and distributing the audible content to one or more other computing devices; and

FIG. 4 illustrates an embodiment of a computing system configured with the example systems and/or methods disclosed.

### DETAILED DESCRIPTION

Systems and methods are described herein as associated with a computer-implemented automated means for obtaining and processing audible content that may be stored on a server and accessible by multiple client computing devices, in one embodiment. The automation serves to record voice notes on a mobile computing device with zero to minimal user interaction using a voice recording application installed and/or accessible by the mobile computing device. The voice recording system begins recording audio immediately upon detection of a first activity, including, for example, a button press (e.g., opening the application) and stops recording upon detection of a second activity, including, for example, a loss of focus by the voice recording application (e.g., pressing a home button, a back button, or turning off the screen). Moreover, the voice recording application may lose focus upon the user pressing a physical button on the mobile device, or the user closing the application.

In one embodiment, the automation provides a simple user interface and operation whereby the user runs a voice recording application on a mobile computing device that automatically begins recording the user's voices notes, memos, sounds, environmental sounds, dictation, thoughts, meetings, lectures, and other audible events. The user can then stop the audio recording by pressing a physical or haptic button of the mobile computing device to close or pause the voice recording application, for example.

In some embodiments, the automation may include saving the recorded audio file to one or more computers via a network (e.g., internet) or computing environment (e.g., a cloud-computing environment). As an example, the voice recording app may store recordings within the app, on a desktop app, or a website by saving the recordings on cloud providers such as AWS, VPS, or others.

In one embodiment, the voice recording application may immediately begin recording audio upon execution, a detected activity on the mobile device, and/or receiving a user input or voice command. The voice recording application may start recording audio from a microphone of the mobile computing device prior to being displayed on the screen and graphical user interface of the mobile device. The voice recording application may include a screen off mode whereby the audio recording continues while the voice recording app runs in the background and listens for a stop recording input such as a user input, a user voice command, or a detected activity on the mobile device.

In one embodiment, the voice recording application may utilize voice recognition algorithms or software and operate based on user voice commands. Further, upon execution the voice memo recording application may take focus and start as a top-level window on the mobile device graphical user interface overlaying the contents of the GUI display and begin recording audio from the microphone.

In some embodiments, the voice recording application may stop recording audio upon receiving an app termination command, a detect activity on the mobile device, and/or receiving a user input or voice command. The automation may then include storing the recorded audio in a file and transmitting the recorded audio file to a computing device, performing a speech to text transliteration on the recorded file to generate a text transcript of the recorded audio, saving the text transcript, transmitting the text transcript to the external system, analyzing the text transcript to parse out commands, and performing one or more third actions based on the commands.

Previous voice recording methods, systems, and applications for obtaining and processing audible content, that can be stored on a server and accessible by multiple client computing devices, often demanded a user's attention to navigate through or visually inspect the state of a voice recording application and then visually confirm a record/stop button is being pressed when operating the voice recording application. The requirement for a user's attention after repeated use, and throughout a day, for example, makes the process of recording voices notes, memos, thoughts, meetings, and other audible events a cumbersome process. For example, active users that are busy driving, working, or engaged in an activity can often find it difficult or dangerous to pause, be distracted, or stop an activity to record voices notes, memos, sounds, environmental sounds, dictation, thoughts, or other audible events. This cumbersome process and inconvenience experienced by users can lead to inaccurate recordings or missed opportunities to take notes of ideas or thoughts.

With the present automated system for obtaining and processing audible content that may be stored on a server and accessible by multiple client computing devices, users can immediately and accurately make voice notes and access recordings through a voice recording mobile application that includes a quick and easy interface providing users with confidence that their notes and thoughts are being recorded and freedom during their busy lives to record their thoughts during their tasks and activities.

### System Embodiment

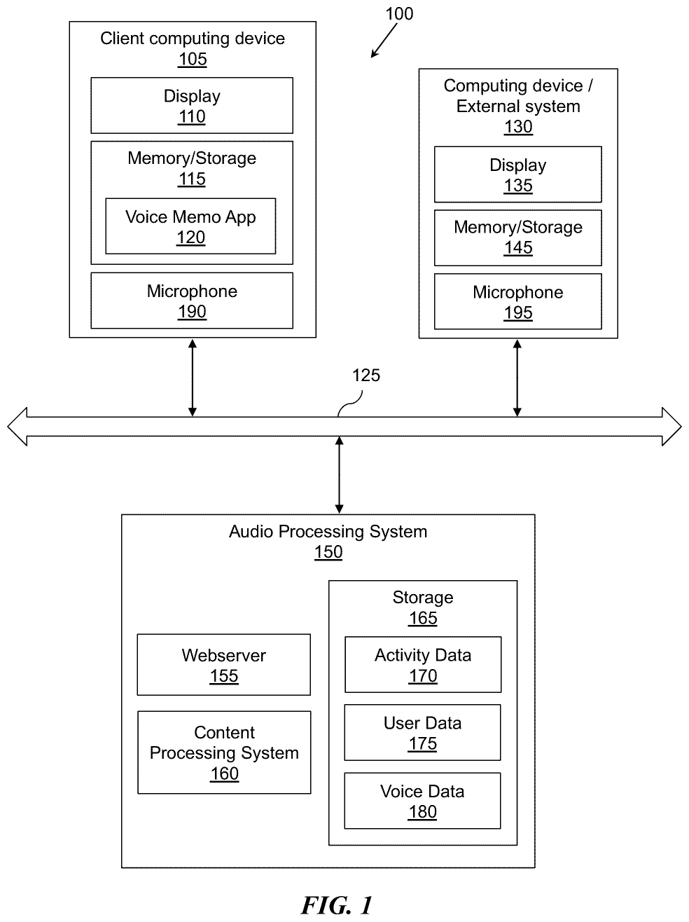

With reference to FIG. 1, one embodiment of a computing environment is illustrated that is configured with an automated voice recording system 100 for obtaining and processing voices notes, voice memos, speeches, utterance, sounds, environmental sounds, dictation, thoughts, meetings, lectures, and other audible events (hereinafter “voice memo”) associated with audible content. In one embodiment, the automated voice recording system 100 is configured to include a client computing device 105, an external system such as a computing device 130, and an audio processing system 150. In one embodiment, the audio content processing system may be a server. In certain embodiments, the audio content processing system may be configured as a database and data server to store and distribute voice memos to one or more client computing devices and external systems such as desktop, laptop, or other stationary or portable computing device. The audio content processing system may be configured to process, trim, or cleanup artifacts, noise, or other unintended or undesirable audio data. Further, the audio content processing system may be configured with one or more machine learning models such as a generative model to transcribe the voice memo (recorded audio file) into a text data file, the text data file may be a textual transcript, diary, or dialog of the voice memo. In some embodiments, the audio content processing system may be configured with one or more text-to-speech (TTS) model(s) to convert the transcribed text data file into an AI or machine spoken audio data file (playback file). The audio content processing system may store the voice memo, the text data file containing a transcription of the voice memo, and the playback file in one or more databases.

In certain embodiments, the voice memo app 120, the client computing device 105, or the computing device 130 may be configured to include a microphone to record audio as a voice memo, store locally and/or remotely the voice memo as a recorded audio file, transcribe the voice memo into a text data file containing a textual transcript, diary, or dialog of the voice memo, to convert the transcribed text data file into an AI or machine spoken audio data file (playback file) using one or more text-to-speech (TTS) model(s), and store the voice memo, the text data file containing a transcription of the voice memo, and the playback file locally and/or on the audio content processing system.

In one embodiment, the audio processing system 150 and/or the client computing device 105 may include, but is not limited to, a computer application/program that includes one or more algorithms configured to generate one or more results based on one or more input values. The algorithm comprises a set of generative models and/or functions that generate one or more transcriptions (text data files) of the voice memos (recorded audio files) using, for example, Automatic Speech Recognition (ASR) models, convert the transcribed text data file into an AI or machine spoken audio data file (playback file) using one or more text-to-speech (TTS) model(s), and store the voice memo, the text data file containing a transcription of the voice memo, and the playback file locally on the client computing device 105 and/or on an external system (e.g., server or computing device), for example.

As shown in FIG. 1, the computing environment (e.g., a cloud-computing environment) of the automated voice recording system 100 may provide access to remote client devices such as client computing device 105 through one or more network communication channels 125 (e.g., a communication bus, wireless communication, wired networks, combinations of channels, etc.). A client device may record, store, and access voice memos on the client device via a graphical user interface through display 110 and a voice memo application 120 stored on or running from memory/storage device 115 to retrieve and process the stored audio content. The voice memo application 120 is configured to record audio (e.g., voice memo) via a microphone 190 of the client device 105 upon receiving a start recording instruction or command and stop recording audio upon receiving a stop recording instruction or command. The upon receiving the stop recording instruction, the voice memo may be stored as a recorded audio file, locally or remotely via one or more network communication channels 125, on at least one of a memory/storage device 115 of the client device 105, a storage 165 of the audio processing system 150, and memory/storage 145 of the computing device.

Moreover, the voice memo application 120 may be instantiated to run automatically based on a user interaction with the client computing device 105. For example, the voice memo application 120 may automatically execute/run to record audio upon the client computing device 105 detecting user activity such as user motion or audible communication. The client computing device 105 may include one or more sensors and/or one or more input devices for detecting user activity that may include: eye movements, hand movements, audible instructions/commands, body movements, gestures, and tactile input communicated to the computing device, for example, via a button press, keypress, screen swipe or press, mouse click, motion sensor controllers (e.g., optical sensors, gyroscope, Light Detection and Ranging (LIDAR), Passive Infrared (PIR), infrared, etc.,), and the like. Further, the user may provide one or more audible instructions to execute the voice memo application 120 to begin or stop recording of a voice memo.

In one embodiment, the client computing device 105 may immediately begin recording audio using the microphone 190 upon execution of the voice memo application 120. In some embodiments, audio may be recorded during the runtime of the voice memo application 120 and prior to the display of the voice memo application 120 on the display 110. For example, a user of client computing device 105 may perform a first activity such as a finger touch on an icon associated with execution of the voice memo application 120 triggering the client device to begin recording audio then displaying the voice memo application 120 on display 110 and a notification that audio is being recorded.

The computing environment of the automated voice recording system 100 may include external computing devices such as computing device 130 through one or more network communication channels 125 (e.g., a communication bus, wireless communication, wired networks, combinations of channels, etc.). A computing device may include laptops, tablets, desktop computers, notepads, smart TVs, and other external computing devices such as smartphones, smart devices with a display, smart controllers, portable consoles, and the like. The computing device 130 may further include a display 135, memory/storage 145, microphone 195, speakers, and other input and output devices described herein for recording and storing a voice memo, viewing and playback of audio transcriptions (text data files) of the voice memos, and playback of recorded audio files.

As described above, the audio processing system 150 is configured to acquire, process, share, and distribute voice memos (i.e., in real-time) and recorded audio files obtained from one or more client computing devices 105 and/or external systems such as computing device 130. The audio processing system 150 may be implemented by one or more machines such as a server including, or communicably coupled to, a database, one or more computer applications/programs, or any combination thereof. The audio processing system 150 may include a webserver 155, processing services 160, storage 165 containing a user's activity data 170, user data 175, and voice data 180.

In one embodiment, the user's activity data 170 includes a timestamp, date, duration, and a local or proximate physical geographic location of where and when the voice memo was recorded. In many embodiments, the local or proximate geographic location may be between 0-1 km. The user activity data 170 may include a listing of any data, file, or combination of files associated with a voice memo share or distribution (e.g., uploaded, downloaded, shared or viewed content) on the automated voice recording system 100. Further the user activity data 170 may include a summary and listing of user and profile information and settings communicated to other computing devices. A combination of user activity data 170 may be used to automatically assign a filename to each recorded audio file. In one embodiment, one or more sub-components of the audio processing system 150 may be integrated within the voice memo application 120. As an example, the voice memo application 120 may track and store user activity data 170 to assign a filename to each voice memo which can include a city and state and time and date as a filename.

The user data 175 includes user settings that define one or more user activities that trigger starting a voice memo recording and stopping a voice memo recording. The user may manually define activities that immediately trigger voice recording, stop recording, and the display of the voice memo application. The voice data 180 includes a store of recorded voice memos and associated transcribed text files that may be distributed to one or more client computing devices 105 and external systems such as computing device 130.

Once the voice memo has been recorded on the client device 105, the client device 105 may display a filename corresponding to the recording and communicate the recorded audio file to the audio processing system 150 for speech to text transcription and text-to-speech (TTS) processing through a content processing system 160. In some embodiments, the client device 105 and computing device 130 may access recorded audio files, text transcripts, and playback audio files using a file browser to access recorded audio files stored on storage 165. In one embodiment, the client device 105 and computing device 130 may access a webserver 155 using a web browser to access, view, play, download, or share the recorded audio files, text transcripts, and playback audio files.

In one embodiment, the content processing system 160 may acquire and transcribe the voice memo communicated from the client device 105 and/or computing device 130 using, for example, speech recognition software installed on the audio processing system 150. The content processing system 160 may group voice memos and their transcripts based on keywords, subjects, times and locations of the recorded voice memo. As an example, a user record voice memos related to work projects, daily meetings, and health goals periodically. A first subset of voice memos may pertain to daily conversations related to work projects and improvements, a second subset of voice memos may pertain to daily notes of meetings and agendas, and a third subset of voice memos may pertain to insights about physical fitness or health goals. The content processing system 160 may analyze, arrange, and tag/label each transcript associated with each voice memo as a “work project” for the first subset, “meetings and agendas” for the second subset, and “health and fitness” for the third subsets. The audio processing system 150 may acquire, store, and access keywords in storage 165 as voice data subject matter for assigning to each recorded voice memo and transcript.

Upon receiving a user activity corresponding to a stop recording of the voice memo, the voice memo application 120 may immediately assign a filename to the recorded audio file and store the file locally and/or communicate the voice memo to the audio processing system 150 for processing. In one embodiment, the audio processing system 150 may process each recorded audio file taken by the client device and communicate the transcript and text-to-speech playback file back to the client device 150 for convenient access. The voice memo application 120 may store recordings and transcripts within the app, on an external system storage 145 such as the computing device 130, or on a website as provided by a webserver 155 of the audio processing system 150. Further, the recorded audio files and transcripts may be stored on cloud providers such as Amazon Webs Services (AWS), a Virtual Private Server (VPS), or others.

### Voice Memo App User Interface and Usage

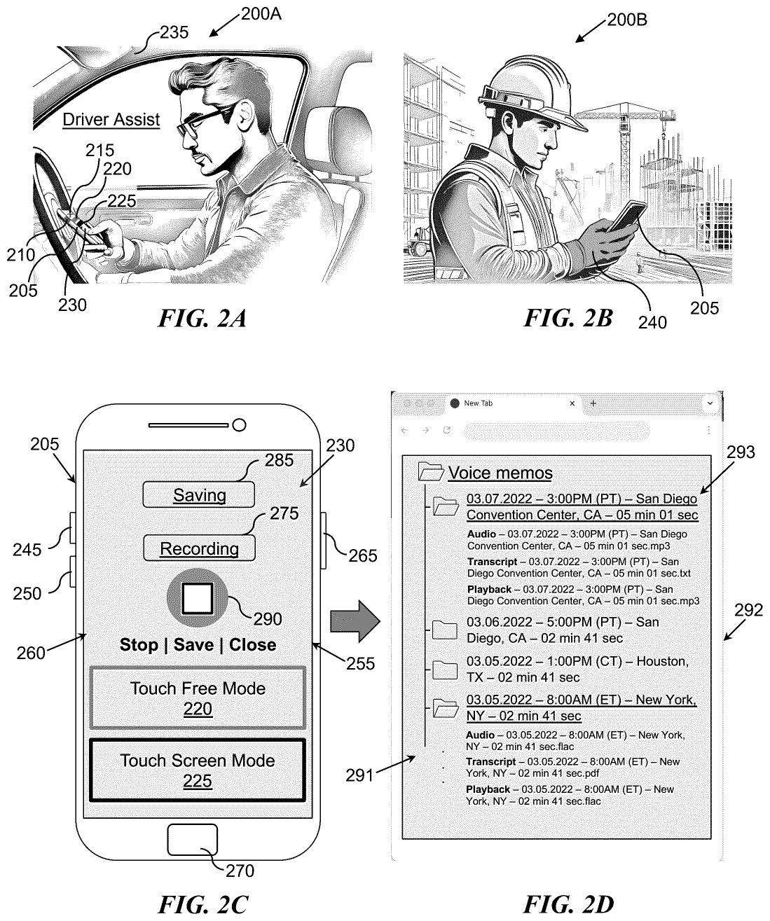

FIG. 2A illustrates one embodiment of a driver assist mode user environment for implementing the voice recording application for recording and processing audible content of FIG. 1. As an example, referring to FIG. 2A, one common user environment 200A where users often find the need to record voice notes and write down thoughts may include their time inside and operating a vehicle 235. As described herein, repeatedly reaching for a mobile device 205 to unlock the device then open and navigate through a mobile application can be distracting, frustrating, and potentially dangerous for the driver, passengers, and others on the road. Safe vehicle operation requires drivers to be alert of their surroundings, aware of any number of potential road hazards and pedestrians, and ready to make split second decisions to avoid accidents. In one embodiment, in order to avoid the need for a driver to repeatedly open and navigate through a mobile application, the voice memo application 230 provides the user with a simple interface to start and stop voice memo recordings by pressing a physical button 210 of the mobile device 205 or simply pressing the voice memo application icon 215 to open/record and closing the voice memo application to stop recording. As shown in FIG. 2C described below, once the voice memo application 230 is launched the user may select a driver mode 220 (touch free mode) and a driver assist mode 225 (touchscreen mode).

The driver mode 220 allows the voice memo application 230 to run in the background while paired to a vehicle's Bluetooth system while being controlled by using preset voice commands to start and stop voice memos recordings. For example, a user saying “Record” will start the recording and the voice memo application 230 will provide an audible confirmation such as “Recording”. Saying a word or a phrase such as “Off” or “Record Stop Command” will stop the recording and the voice memo application 230 will provide an audible confirmation such as “Recording stopped”.

The driver assist mode 225 allows the voice memo application 230 to open and closed through a vehicle's radio or head unit display after the mobile device is synced with the vehicle (e.g., CarPlay, Android Auto, or other Bluetooth/Wi-Fi system, etc. ,) whereby the vehicle radio or head unit (e.g., touch display) is the controller for the mobile device. Once the voice memo application 230 runs through the car's touch screen display, a user can start and stop recording by subsequent touch press on the car's touch screen display. When the user selects the voice memo application 230 icon on the car's touch screen display, it will automatically start recording and the screen will display “Recording,” pressing the voice memo application 230 icon on the car's touch screen display again will stop the recording and save it.

With the present voice recording application, a vehicle operator or passenger would not need to hold their mobile device and repeatedly cycle through the graphical user interface of the mobile device to access the voice recording application to start and stop recordings of thoughts or notes. By providing users with the automated voice recording system of the present disclosure, users can focus on driving and safely operating a vehicle while simultaneously taking down notes or thoughts for short and/or extended periods of time.

FIG. 2B illustrates one embodiment of a user environment for implementing the voice recording application for recording and processing audible content of FIG. 1. As an example, referring to FIG. 2B, another common user environment 200B where users often find the need to record voice notes and write down thoughts can include an active or noisy job site. The user can either be in a loud or noisy environment where it can be difficult to record audio using voice commands instead relying on touch interactions such as a physical button press, or preoccupied and physically unable (e.g., working or wearing a glove 240) to press a button or operate the touch screen of the mobile device 205. In one embodiment, the voice memo application 230 may include a screen off mode whereby the mobile device 205 places the voice memo application 230 to run in the background and turns off the mobile device display and listens for a voice command to start recording (e.g., “Record) and to stop recording (e.g., “Record Stop Command”). Further, users can set a word or phrase to active the voice memo application 230 and another word or phrase to deactivate the voice memo application 230 the voice memo application 230 can perform the action regardless of the state of the mobile device display whether on or off. For example, saying “Record” will start the recording and the voice memo application 230 will provide an audible confirmation such as “Recording”. Saying “Off” will stop the recording, and the voice memo application 230 will provide an audible confirmation such as “Recording stopped”.

With the present voice recording application, a user can perform any activity such as walking, hiking, yard work, and other outdoor or indoor activities without the need to consistently reach for through mobile device to access a voice recording application to start and stop recordings of thoughts or notes. By providing users with the automated voice recording system of the present disclosure, users can easily record to-do lists, voice memos, speeches, dictation, and thoughts without needing to repeatedly navigate through the mobile device or voice recording application.

FIG. 2C illustrates one embodiment of a mobile user interface displaying the voice recording application for recording and processing audible content of FIG. 1. The user may select from several settings for the voice memo application 230 behavior whereby the voice memo application 230 is configured to start and stop recording of a voice memo through minimal user interaction. As an example, the voice memo application 230 may be configured to operate in a focus/lost focus mode. In the focus/lost focus mode, the voice memo application 230 begins recording immediately upon execution of voice memo application 230 from the client device 205, the voice memo application 230 then displays a recording notification 275 on a top level of GUI 260 of the client device display 255. Upon any physical button press (e.g., volume 245/250, power 265, or home button 270 press), touchscreen press (e.g., any object on the touch screen), or a screen turn off button press or command (e.g., voice command) the voice memo application 230 loses focus and immediately displays a saving file notification 285 and stops recording the voice memo and saves the voice memo locally on storage 115, or sends the file for remote storage on storage 145 of computing device 130, or storage 165 of audio processing system 150, or any combination thereof. As shown in FIG. 2D described below, upon recording of the voice memo, the recorded audio file may undergo further processing such as transcription, text-to-speed playback, and uploaded/shared to a webserver or cloud storage to be accessible through a file browser or web browser, as described herein.

In one embodiment, the voice memo application 230 may be configured to operate in an auto start/manual stop and close mode. focus/lost focus mode. In the auto start/manual stop and close mode, the voice memo application 230 begins recording immediately upon execution of the voice memo application 230 from the client device 205, the voice memo application 230 then displays a recording notification 275 on a top level of GUI 260 of the client device display 255, displays a stop/close button 290 that when pressed saves the recording of the voice memo, displays a saving file notification 285, and immediately closes the voice memo application 230. In certain embodiments, the voice memo application 230 may stop recording the voice memo and save the voice memo upon any physical button press (e.g., volume 245/250, power 265, or home button 270 press), touchscreen press (e.g., any object on the touch screen), or a screen turn off button press or command (e.g., voice command), the voice memo application 230 loses focus and immediately displays a saving file notification 285 and stops recording the voice memo and saves the voice memo locally on storage 115, or sends the file for remote storage on storage 145 of computing device 130, or storage 165 of audio processing system 150, or any combination thereof. In one embodiment, the voice memo application 230 loses focus upon starting or stopping of a voice recording whereby the voice memo application 230 is configured to become minimized and/or run in the background of the mobile computing device 205 along with other idle applications or background services or processes.

FIG. 2D illustrates one embodiment of a web user interface displaying the voice recording application for recording and processing audible content of FIG. 1. The audio processing system 150 may provide a webserver 155 or storage 165 (e.g., cloud storage) to share and distribute, via a listing 293, all recorded voice memos, generated transcripts of the voice memos, and playback files generated from the voice memo transcripts (e.g., AI generated memo playback files generated through one or more TTS model(s)). Users can access recorded and generated files associated with their voice memos through any computing device with a display 291 and file or web browser 292. In one embodiment, the voice memo may contain instructions and commands that will be saved in the corresponding text transcript of the voice memo that can be parsed and analyzed at a later time by the content processing system 160 to parse out commands, and perform one or more third actions based on the commands, for example, adding an event, appointment, or meeting to the user's calendar, adding a reminder to a reminder or notetaking application, or sending a text message to a phone number based on information and instructions in the transcript of the recorded voice memo.

### Run-Time or Operational Method

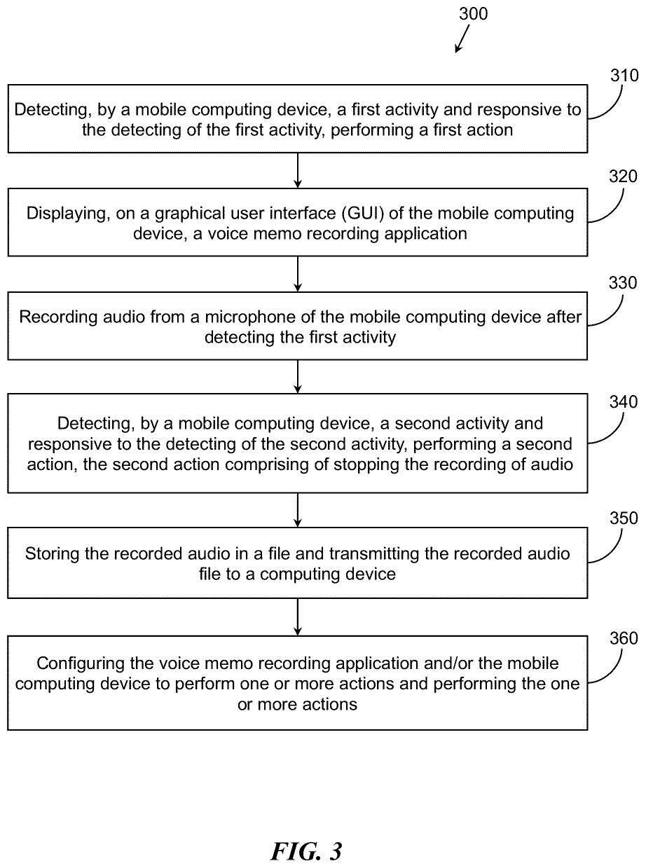

FIG. 3 illustrates one embodiment of a run-time or operational method 300 that is associated with a run-time or operational user interaction with the automated voice recording system 100 of FIG. 1. The method may include various programs, algorithms, logic, applications, and systems for obtaining, displaying, and processing voices notes, voice memos, speeches, utterance, sounds, environmental sounds, dictation, thoughts, meetings, lectures, and other audible events (hereinafter “voice memo”) associated with audible content. Each block shown in FIG. 3 may represent one or more processes, methods, or subroutines, carried out in the exemplary method. For explanatory purposes, method 300 will be described with reference to FIGS. 1, 2A-2C, and 4 which show example embodiments of carrying out the method of FIG. 3 for obtaining, displaying, and processing voices notes, voice memos, speeches, utterance, sounds, environmental sounds, dictation, thoughts, meetings, lectures, and other audible events (hereinafter “voice memo”) associated with audible content. Method 300 may be used independently or in combination with other methods or processes for obtaining, displaying, and processing voices notes, voice memos, speeches, utterance, sounds, environmental sounds, dictation, thoughts, meetings, lectures, and other audible events (hereinafter “voice memo”) associated with audible content. Method 300 may be performed by the voice memo application 120 of the client computing device 105, the audio processing system 150, or both.

Method 300 begins at block 310, the method includes detecting, by a mobile computing device, a first activity and responsive to the detecting of the first activity, performing a first action. In one embodiment, the computing device may record audio from a microphone after detecting the first activity and prior to the displaying of the voice memo recording application. The first activity may be configured to include one or more of: a voice command that triggers a mobile computing device to perform voice recognition, a physical button or a touch press whereby a button, object, or icon is pressed. The first activity may be configured to execute the voice memo recording application thereby starting or stopping an audio recording session by computing device. With reference to FIGS. 2A-2C, the first activity may include various user touch interactions that trigger a first action by the computing device.

In block 320, the method includes displaying, on a graphical user interface (GUI) of the mobile computing device, a voice memo recording application. In one embodiment, the first action comprises displaying the voice memo recording application on a top level of the GUI overlaying the contents of the GUI display and recording audio from the microphone. In certain embodiments, the first action may further include displaying a “Recording” notification on screen to notify the user that computing device is recording audio. With reference to FIGS. 2A-2C, the first action may depend on user settings for the voice memo application behavior as described herein.

In block 330, the method includes recording audio from a microphone of the mobile computing device after detecting the first activity. In certain embodiments, the voice memo recording application may instruct the mobile computing device to begin recording audio and display an on-screen “Recording” notification prior to displaying the voice memo recording application on a graphical user interface (GUI) of the mobile computing device. With reference to FIG. 2A, a vehicle operator may need to begin recording immediately on a touch or button press to minimize distractions from operating a vehicle.

In block 340, the method includes detecting, by a mobile computing device, a second activity and responsive to the detecting of the second activity, performing a second action, the second action comprising of stopping the recording of audio. In certain embodiments, detecting, by a mobile computing device, a second activity and responsive to the detecting of the second activity, performing a second action may include displaying a “Saving” or “Storing Recording” notification may be displayed on the mobile device display to confirm the voice memo has been saved. Further, the second action may include storing the recorded audio in a file and transmitting the recorded audio file to a computing device. In some embodiments, the second action may include at least one of: performing a speech to text transliteration on the recorded file to generate a text transcript of the recorded audio, saving the text transcript, transmitting the text transcript to the external system, analyzing the text transcript to parse out commands, and performing one or more third actions based on the parsed commands.

In one embodiment, the second activity may include one or more of: a voice command that triggers the mobile computing device to perform voice recognition, pressing on an object associated with a voice memo recording application, pressing on a home button of the mobile computing device, pressing on a back button of the mobile computing device, turning off the screen of the mobile computing device, and pressing on a physical button or haptic button of the mobile computing device.

In block 350, the method includes storing the recorded audio in a file and transmitting the recorded audio file to a computing device. In block 360, the method includes configuring the voice memo recording application and/or the mobile computing device to perform one or more actions and performing the one or more actions. In one embodiment, the first action may include turning off the screen of the mobile computing device, running the voice memo application in the background, and configuring the mobile computing device to perform at least one of the first action and the second action responsive to a preset voice command.

### Definitions

A “audio content”, “voice memo”, “audio”, “voice”, “recording”, “note”, “audio file”, “recorded voice memo”, “recorded memo”, “file” or “recorded file” as used herein includes, but is not limited to, any singular or sequence of sounds, oscillations in pressure, or wave motion in air or other elastic media collected by a sensor (e.g., microphone) of a computing device and reproduced, stored, processed, or capable of being processed by a computing device.

A “mobile device”, “client device”, “client computing device”, “client”, “mobile” or “mobile computing device”, as used herein includes, but is not limited to, any computing device, portable, mobile, or stationary (e.g., desktop computer), including a processor and a memory/storage and capable of processing one or more user requests or inputs.

### Computing Device Embodiment

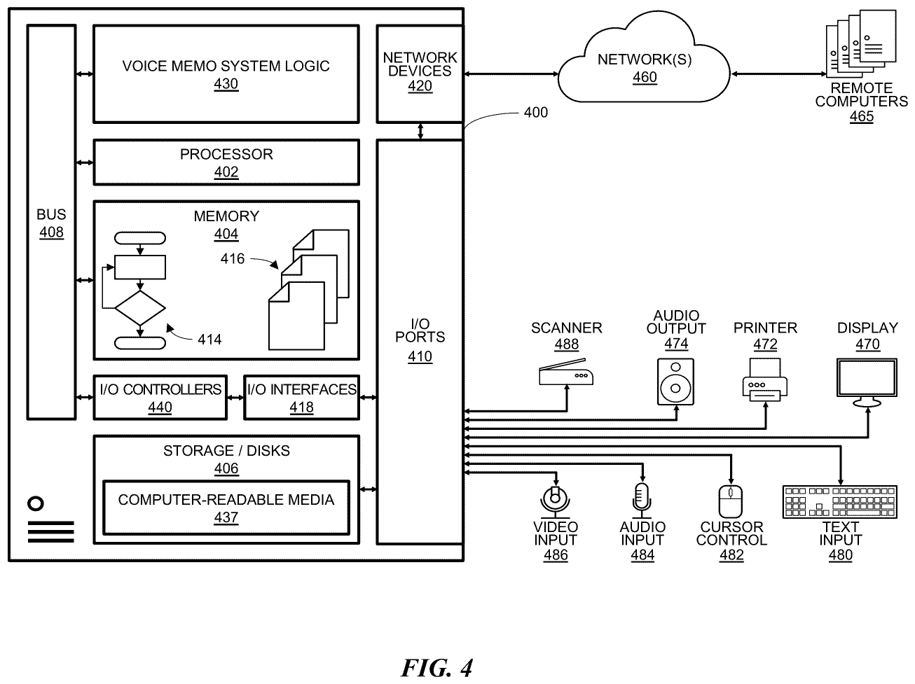

FIG. 4 illustrates an example computing device that is configured and/or programmed as a special purpose computing device with one or more of the example systems and methods described herein, and/or equivalents. The example computing device may be a computer 400 that includes at least one hardware processor 402, a memory 404, and input/output ports 410 operably connected by a bus 408. In one example, the computer 400 may include voice memo system logic 430 configured to facilitate obtaining, displaying, and processing voices notes, voice memos, speeches, utterance, sounds, environmental sounds, dictation, thoughts, meetings, lectures, and other audible events (hereinafter “voice memo”) associated with audible content immediately and accurately with minimal to zero user interaction as the automated voice recording system 100 and associated figures. The voice memo system logic 430 generates and distributes recorded audible content, transcripts of the recorded audible content, and playback of the transcript. In different examples, the logic 430 may be implemented in hardware, a non-transitory computer-readable medium 437 with stored instructions, firmware, and/or combinations thereof. While the logic 430 is illustrated as a hardware component attached to the bus 408, it is to be appreciated that in other embodiments, the logic 430 could be implemented in the processor 402, stored in memory 404, or stored in disk 406.

In one embodiment, logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate serial or parallel execution of obtaining, displaying, and processing voices notes, voice memos, speeches, utterance, sounds, environmental sounds, dictation, thoughts, meetings, lectures, and other audible events (hereinafter “voice memo”) associated with audible content immediately and accurately with minimal to zero user interaction. The means may also be implemented as stored computer executable instructions that are presented to computer 400 as data 416 that are temporarily stored in memory 404 and then executed by processor 402.

Logic 430 may also provide means (e.g., hardware, non-transitory computer-readable medium that stores executable instructions, firmware) for performing one or more of the disclosed functions and/or combinations of the functions.

Generally describing an example configuration of the computer 400, the processor 402 may be a variety of various processors including dual microprocessor and other multi-processor architectures. A memory 404 may include volatile memory and/or non-volatile memory. Non-volatile memory may include, for example, ROM, PROM, and so on. Volatile memory may include, for example, RAM, SRAM, DRAM, and so on.

A storage disk 406 may be operably connected to the computer 400 via, for example, an input/output (I/O) interface (e.g., card, device) 418 and an input/output port 410 that are controlled by at least an input/output (I/O) controller 440. The disk 406 may be, for example, a magnetic disk drive, a solid-state disk drive, a floppy disk drive, a tape drive, a Zip drive, a flash memory card, a memory stick, and so on. Furthermore, the disk 406 may be a CD-ROM drive, a CD-R drive, a CD-RW drive, a DVD ROM, and so on. The memory 404 can store a process 414 and/or a data 416, for example. The disk 406 and/or the memory 404 can store an operating system that controls and allocates resources of the computer 400.

The computer 400 may interact with, control, and/or be controlled by input/output (I/O) devices via the input/output (I/O) controller 440, the I/O interfaces 418, and the input/output ports 410. Input/output devices may include, for example, one or more displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 406, network devices 420, and so on. The input/output ports 410 may include, for example, serial ports, parallel ports, and USB ports.

The computer 400 can operate in a network environment and thus may be connected to the network devices 420 via the I/O interfaces 418, and/or the I/O ports 410. Through the network devices 420, the computer 400 may interact with a network 460. Through the network, the computer 400 may be logically connected to remote computers 465. Networks with which the computer 400 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising”as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, the method comprising:
detecting, by a mobile computing device, a first activity and responsive to the detecting of the first activity, performing a first action;
displaying, on a graphical user interface (GUI) of the mobile computing device, a voice memo recording application;
recording audio from a microphone of the mobile computing device after detecting the first activity; and
triggering, by the voice memo recording application, the microphone to immediately stop recording upon losing focus.

2. The method of claim 1, further comprising recording audio from a microphone of the mobile computing device after detecting the first activity and prior to the displaying of the voice memo recording application.

3. The method of claim 1, further comprising configuring the first activity to include one or more of: a voice command that triggers the mobile computing device to perform voice recognition and pressing on an object associated with execution of the voice memo recording application to launch the voice memo recording application.

4. The method of claim 1, wherein the first action comprises displaying the voice memo recording application on a top level of the GUI overlaying the contents of the GUI display and recording audio from the microphone.

5. The method of claim 1, further comprising detecting, by a mobile computing device, a second activity causing the voice memo recording application to lose focus, and responsive to the detecting of the second activity, performing a second action, the second action comprising of stopping the recording of audio.

6. The method of claim 5, wherein the second action comprises storing the recorded audio in a file and transmitting the recorded audio file to a computing device, and at least one of: performing a speech to text transliteration on the recorded file to generate a text transcript of the recorded audio, saving the text transcript, transmitting the text transcript to the external system, analyzing the text transcript to parse out commands, and performing one or more third actions based on the parsed commands.

7. The method of claim 5, further comprising configuring the second activity to include one or more of: a voice command that triggers the mobile computing device to perform voice recognition, pressing on an object associated with a voice memo recording application, pressing on a home button of the mobile computing device, pressing on a back button of the mobile computing device, turning off the screen of the mobile computing device, and pressing on a physical button or haptic button of the mobile computing device.

8. The method of claim 5, the first action further comprising turning off the screen of the mobile computing device, running the voice memo application in the background, and configuring the mobile computing device to perform at least one of the first action and the second action responsive to a preset voice command.

9. A non-transitory computer-readable medium that includes stored thereon computer-executable instructions that when executed by at least a processor of a computer cause the computer to:
detect, by a mobile computing device, a first activity and responsive to the detection of the first activity, perform a first action;
display, on a graphical user interface (GUI) of the mobile computing device, a voice memo recording application;
record audio from a microphone of the mobile computing device after detecting the first activity; and
trigger, by the voice memo recording application, the microphone to immediately stop recording upon losing focus.

10. The non-transitory computer-readable medium of claim 9, further comprising instructions that when executed by at least the processor cause the processor to:
record audio from a microphone of the mobile computing device after detection of the first activity and prior to the display of the voice memo recording application.

11. The non-transitory computer-readable medium of claim 9, further comprising instructions that when executed by at least the processor cause the processor to:
configure the first activity to include one or more of: a voice command that triggers the mobile computing device to perform voice recognition and a pressing on an object associated with execution of the voice memo recording application to launch the voice memo recording application.

12. The non-transitory computer-readable medium of claim 9, further comprising instructions that when executed by at least the processor cause the processor to:
display the voice memo recording application on a top level of the GUI to overlay the contents of the GUI display and record audio from the microphone.

13. The non-transitory computer-readable medium of claim 9, further comprising instructions that when executed by at least the processor cause the processor to:
detect, by a mobile computing device, a second activity causing the voice memo recording application to lose focus, and responsive to the detection of the second activity, perform a second action, the second action comprising of stopping the recording of audio.

14. The non-transitory computer-readable medium of claim 13, further comprising instructions that when executed by at least the processor cause the processor to:
store the recorded audio in a file and transmit the recorded audio file to a computing device, and at least one of: perform a speech to text transliteration on the recorded file to generate a text transcript of the recorded audio, save the text transcript, transmit the text transcript to the external system, analyze the text transcript to parse out commands, and perform one or more third actions based on the parsed commands.

15. The non-transitory computer-readable medium of claim 13, further comprising instructions that when executed by at least the processor cause the processor to:
configure the second activity to include one or more of: a voice command that triggers the mobile computing device to perform voice recognition, a pressing on an object associated with execution of the voice memo recording application, a pressing on a home button of the mobile computing device, a pressing on a back button of the mobile computing device, a turning off the screen of the mobile computing device, and a pressing on a physical button or haptic button of the mobile computing device.

16. The non-transitory computer-readable medium of claim 13, further comprising instructions that when executed by at least the processor cause the processor to:
turn off the screen of the mobile computing device, run the voice memo application in the background, and configure the mobile computing device to perform at least one of the first action and the second action responsive to a preset voice command.

17. A computing system, comprising:
at least one processor connected to at least one memory;
a non-transitory computer readable medium including instructions stored thereon that when executed by at least the processor cause the processor to:
detect, by a mobile computing device, a first activity and responsive to the detection of the first activity, perform a first action;
display, on a graphical user interface (GUI) of the mobile computing device, a voice memo recording application;
record audio from a microphone of the mobile computing device after detecting the first activity; and
trigger, by the voice memo recording application, the microphone to immediately stop recording upon losing focus.

18. The computing system of claim 17, wherein the instructions further include instructions that when executed by at least the processor cause the processor to:
configure the first activity to include one or more of: a voice command that triggers the mobile computing device to perform voice recognition and a pressing on an object associated with execution of the voice memo recording application to launch the voice memo recording application.

19. The computing system of claim 17, wherein the instructions further include instructions that when executed by at least the processor cause the processor to:
detect, by a mobile computing device, a second activity causing the voice memo recording application to lose focus, and responsive to the detection of the second activity, perform a second action, the second action comprising of stopping the recording of audio.

20. The computing system of claim 19, wherein the instructions further include instructions that when executed by at least the processor cause the processor to:
store the recorded audio in a file and transmit the recorded audio file to a computing device, and at least one of: perform a speech to text transliteration on the recorded file to generate a text transcript of the recorded audio, save the text transcript, transmit the text transcript to the external system, analyze the text transcript to parse out commands, and perform one or more third actions based on the parsed commands.
